(19) United States
(12) Patent Application Publication
(10) Pub. No.: US 2003/0002928 A1
(43) Pub. Date: Jan. 2, 2003

(54) Hobbing cutter

(76) Inventors: Wolfgang Soltau, Neu Darchau (DE); Klaus Oppelt, Lauenburg (DE); Wolfgang Carmincke, Scharnebeck (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/174,663

(22) Filed: Jun. 18, 2002

(30) Foreign Application Priority Data
Jun. 28, 2001 (DE) 101 31 333.0

(51) Int. Cl. B23F 21/16; B26D 1/12

(52) U.S. Cl. 407/23; 407/119

(57) ABSTRACT

A hobbing cutter, comprising:

a steel basic body which is formed as an equilateral polygon in cross-section, and

cemented-carbide segments having the length of a polygon side, which include one or more cutting edges, with the segments being mounted on the basic body and forming a tool unit together.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Hobbing cutters, first and foremost, are used for manufacturing toothed components such as gears, worm gears, racks and the like. Generally, a distinction is made between a bore-type design and a shank-type design. In the bore-type design, the bore is provided with a longitudinal groove for a positive torque transmission. As an alternative, the bore may be made with a one-sided or two-sided transverse groove for a positive torque transmission. However, a bore design using front-side frictional transmission is known as well. In the shaft-type design, two-sided shanks are integrally formed with the tool body for a non-positive torque transmission. The shanks may be tapered on the two sides, or tapered on one side and cylindrical on the other side. The conical shanks may be hollow or may also be designed as a steep-angle taper.

The material primarily used for such hobbing cutters is high-speed steel. However, it is also known to manufacture hobbing cutter bodies from cemented carbide. Cemented carbide is a term which comprehends materials made by powder metallurgy which substantially consist of the tungsten carbide, titanium carbide, and tantalum carbide materials and cobalt as a binder. Cemented carbides exhibit an increased wear resistance to steel and, therefore, may be used for inserts having a higher cutting speed, i.e. also for dry machining. The temperature limit for cemented carbide insert use is far higher than that of steel, e.g. about 1000° C.

Cemented carbide, however, inherently is of a relative high brittleness. This is why bumps and shocks may rapidly damage the tool the manufacture of which involves exceptional expenditure.

It is also known to fix a cemented-carbide hollow tool body to a shank made of steel. Fixing is primarily done by soldering. The advantage of this embodiment is that solely the tool portion proper is made of the favourable cemented-carbide material whereas the shank is formed from material involving little expenditure. Further, it is known to provide the tool body of a hobbing cutter with a hard-material coating (e.g. titanium nitrite) in the so-called PVD process. The coating is applied after the tool body is finish-machined on the steel shaft. This is necessary for reasons of accuracy. Coating is performed at relatively high temperatures, e.g. 500° C. Since steel has a distinctly higher coefficient of expansion than has a cemented carbide there is a risk of the tool body being destroyed by the temperature-induced expansion of the steel shaft.

It is the object of the invention to provide a hobbing cutter the core of which is made of steel and the tool body of which is made of cemented carbide and can be subjected to higher temperatures with the temperature-induced expansion of the steel core not having an adverse effect on the tool body.

### BRIEF SUMMARY OF THE INVENTION

In the inventive design of a hobbing cutter, the steel basic body is formed as an equilateral polygon in cross-section, e.g. as a hexagon or octagon. Cemented-carbide segments having the length of a polygon side, which include one or more cutting edges, are mounted on the basic body in such a way that they form a tool unit together. The segments may be soldered to the basic body or may be joined thereto in a positive fit with the sides of the basic body, according to an aspect of the invention, each having defined an axially parallel groove therein which is engaged by a ledge-shaped protrusion, for this purpose.

The process for manufacturing the inventive hobbing cutter provides that cemented-carbide segments having an incomplete or pre-profiled contour are mounted on a steel basic body which is formed as an equilateral polygon in cross-section. The tool unit is finish-machined subsequently. The segments may be formed from sintered metal with no profile before being mounted on the basic body. As an alternative, they may first be pre-profiled by sintering and be mounted on the basic body afterwards. The profile will then only be finish-ground once they are on the basic body.

### BRIEF DESCRIPTION OF THE SEVERAL VIEWS OF THE DRAWINGS

The invention will be explained in greater detail below with reference to the drawings.

FIG. 1 shows a section through a hobbing cutter according to the invention.

FIG. 2 shows a side view of the basic body of the hobbing cutter of FIG. 1.

FIG. 3 shows a segment of the hobbing cutter of FIG. 1 with an outlined profile.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrared.

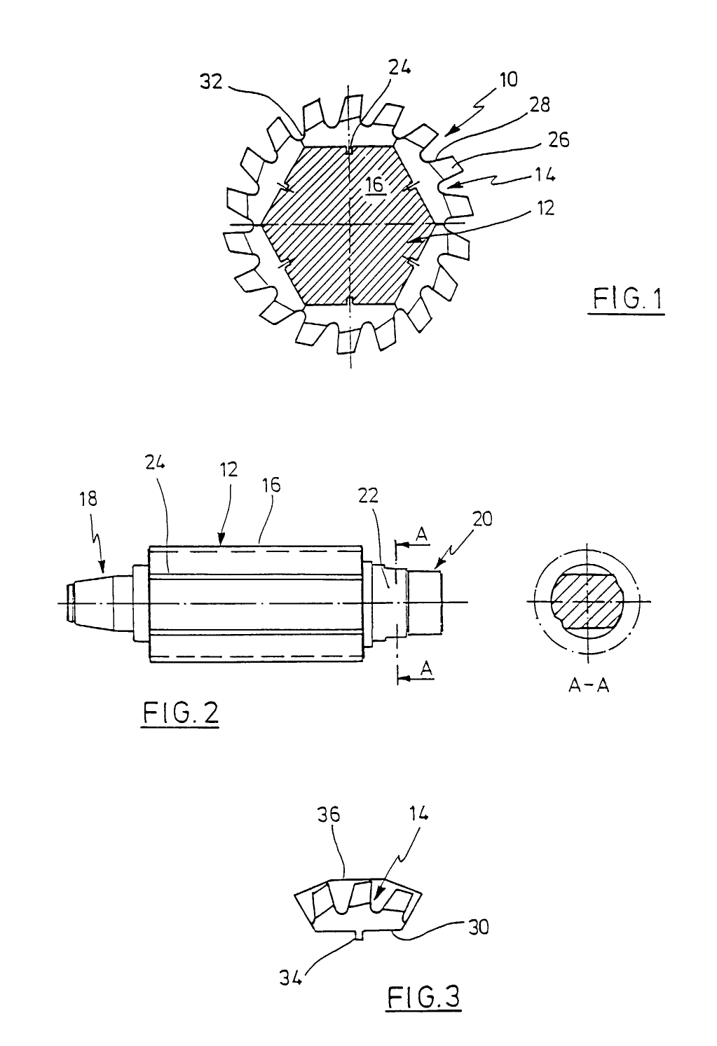

Referring to FIG. 1, a hobbing cutter 10 is shown in a cross-section. It is comprised of a basic body 12 and individual cutting edge segments 14. The basic body 12 is illustrated in a side view and a section along lines A-A in FIG. 2. A central portion 16 of the basic body 12 is an equilateral hexagon in cross-section. One end of the portion 16 has formed thereto a clamping taper and the other end has formed thereto a cylindrical gudgeon 20 which exhibits a portion 22 that is provided with opposed flattened areas as is shown in the A-A section. The configuration of the gudgeons 18, 20 is conventional.

The basic body 12 manufactured from steel has axially parallel grooves 24, which are of a rectangular shape in cross-section, at the sides in the central portion.

The cutting edge segments 14 six of which are joined to the basic body 12 are formed from an appropriate cemented carbide. Each segment has three milling teeth 26 between which grooves 28 are disposed. The configuration of the teeth 26 and grooves 28 is conventional. On the side facing the basic body 12, the segments 14 are provided with a surface 30 the length of which corresponds to one side each of a surface of the basic body 12. For instance, the length of the segments corresponds to the length of the basic body portion 16. However, the length may be smaller so that two or more segments 14 are successively disposed in an axially parallel direction. Expansion joints 32 are provided between the segments 14 and even if the segments 14 are axially disposed side by side an expansion joint requires to be provided between them in order to compensate the different expansion of the material of the basic body 12, on one hand, and the segments 14, on the other.

Centrally extending from the surface 30 of the cutting edge segments 14 is a ledge-shaped protrusion 34 which is adapted to be fittingly inserted into a groove 24 of the basic body 12.

For the manufacture of the segments 14, pre-formed segments are initially manufactured from cemented carbide, e.g. by using a sintering method as is outlined by the bold continuous line 36 in FIG. 3. These segments are mounted on the basic body 12 and fixed by soldering, for instance. This is followed by forming the milling teeth 26 as can be seen from FIG. 1.

It is also imaginable to pre-profile the segments 14 and to finish-machine them subsequently, e.g. by grinding, after mounting them on the basic body 12.

The above Examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A hobbing cutter, comprising:
a steel basic body (12) which is formed as an equilateral polygon in cross-section, and
cemented-carbide segments (14) having the length of a polygon side, which include one or more cutting edges, with the segments (14) being mounted on the basic body (12) and forming a tool unit together.

2. The hobbing cutter according to claim 1, characterized in that there is a positive fit between the segments (14) an the basic body.

3. The hobbing cutter according to claim 1, characterized in that the sides of the basic body (12) each have defined therein an axially parallel groove (24) which is engaged by a ledge-shaped protrusion (34) of the segments (14).

4. The hobbing cutter according to claim 1, characterized in that the basic body (12) is hexagonal and, accordingly, provides six segments (14) wherein each segment (14) has three milling teeth (26) which are successively offset in a circumferential direction.

5. A process for manufacturing a hobbing cutter, particularly according to claim 1, characterized in that cemented-carbide segments having an incomplete or pre-profiled contour are mounted on a steel basic body which is formed as an equilateral polygon in cross-section, and that the tool unit thus formed is finish-machined subsequently.

6. The process according to claim 5, characterized in that the segments (36) are formed from sintered material in a non-profiled shape.

7. The process according to claim 5, characterized in that the segments undergo pre-profiling and are finish-machined subsequently after being mounted on the basic body.
